(19) United States
(12) Patent Application Publication
(10) Pub. No.: US 2008/0120348 A1
(43) Pub. Date: May 22, 2008

(54) DATA-ORIENTED PROGRAMMING MODEL FOR LOOSELY-COUPLED APPLICATIONS

(76) Inventors: JOHN FIELD, Newtown, CT (US); Rafah A. Hosn, New York, NY (US); Bruce David Lucas, Mohegan Lake, NY (US); Maria-Cristina V. Marinescu, White Plains, NY (US); Christian Oskar Erik Stefansen, Kobenhavn N (DK); Mark N. Wegman, Ossining, NY (US); Charles Francis Wiecha, Hastings on Hudson, NY (US)

Correspondence Address: KEUSEY, TUTUNJIAN & BITETTO, P.C., Suite 210, 20 Crossways Park North, Woodbury, NY, 11797, US

(21) Appl. No.: 11/756,695

(22) Filed: Jun. 1, 2007

Related U.S. Application Data
(60) Provisional application No. 60/860,151, filed on Nov. 20, 2006.

(51) Int. Cl. G06F 17/30

(52) U.S. Cl. 707/201; 707/E17.005

(57) ABSTRACT

A reactor and method configured to maintain data consistency. The reactor includes an inbox configured to receive update information. An apply operation is configured to apply the update information to a prestate to determine a stimulus state based on the update information. A response state is derived in accordance with the stimulus state. The response state is an only state externally visible from the reactor.

### CROSS-REFERENCE TO RELATED APPLICATIONS

This application claims the benefit of U.S. Provisional Application Ser. No. 60/860,151, filed Nov. 20, 2006, which is incorporated by reference herein in its entirety.

### BACKGROUND

1. Technical Field

The present invention relates to programming models and more particularly to systems and methods for synchronous and asynchronous data-oriented programming models for loosely coupled applications.

2. Description of the Related Art

In modern web applications, traditional boundaries between browser-side presentation logic, server-side “business” logic, and logic for persistent data access and query are rapidly blurring. This is particularly true in so-called web mash-ups, which bring a variety of data sources and presentation components together in a browser, often using asynchronous (“AJAX”) logic. Such applications must currently be programmed using an agglomeration of data access languages, server-side programming models, and client-side scripting models meaning that programs have to entirely rewritten or significantly changed to be shifted between tiers. The large variety of languages involved also means that components do not compose well without painful amounts of scaffolding.

### SUMMARY

A uniform programming model is provided herein for a full spectrum of web and other loosely-coupled distributed applications, i.e., a model that can express application logic, user interaction, and application logic using the same basic programming constructs. In addition to providing a single programming method, the model simplifies composition, evolution, and maintenance of distributed web applications.

A reactor and method thereof configured to build and evolve programs including an inbox configured to queue update bundles for addition and deletion operations. An apply operation is configured to compare a prestate to an update bundle to determine a stimulus state based on the additions and deletions provide by the update bundle. A response state is derived in accordance with the stimulus state. The response state is externally visible from the reactor.

A reactor and method configured to maintain data consistency. The reactor includes an inbox configured to receive update information. An apply operation is configured to apply the update information to a prestate to determine a stimulus state based on the update information. A response state is derived in accordance with the stimulus state. The response state is an only state externally visible from the reactor.

A reactor implemented on a computer useable medium including a computer readable program, wherein the computer readable program when executed on a computer maintains data consistency in a distributed network, the reactor includes an inbox configured to receive update information, an apply operation configured to apply the update information to a prestate to determine a stimulus state based on the update information, and a response state in accordance with the stimulus state. The response state is an only state externally visible from the reactor by other components in a distributed network system.

A reactor implemented on a computer useable medium including a computer readable program, wherein the computer readable program when executed on a computer maintains data consistency in a distributed network, the reactor includes a reactor state provided in accordance with at least one relation associated with the reactor, wherein the reactor state is modifiable in accordance with update information received in a distributed network system. At least one rule is configured to maintain data consistency such that if consistency is violated a reaction fails, such that the reactor state is rolled back to a state before the reaction was initiated.

A method for maintaining data consistency in distributed systems, includes inputting update information to a reactor, executing all rules in all involved reactors atomically and in any order to determine at least one of a response state and a future state for the reactor and other reactors in a reaction, if at least one rule fails to be satisfied, rolling back all involved reactors atomically to their respective states before the reaction, and if all rules in the reaction are satisfied, generating update information for other reactors to maintain data consistency throughout a distributed system.

A system configured to maintain data consistency includes a plurality of reactors disposed within a distributed system, wherein each reactor includes an inbox configured to receive update information, an apply operation configured to apply the update information to a prestate to determine a stimulus state based on the update information, and a response state derived in accordance with the stimulus state. The response state is an only state externally visible from the reactor wherein each reactor is at least one of asynchronously responsive to update information from other reactors including the reactor itself and synchronously responsive to data being written from other reactors.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing illustrative core syntax for reactors in accordance with the present principles;

FIG. 2 is a diagram showing illustrative rewrite rules which can be executed by reactors in accordance with the present principles;

FIG. 3 is a block/flow diagram showing a reactor in accordance with the present principles;

FIGS. 4A and 4B is a diagram respectively showing asynchronous and synchronous references to other reactors in accordance with the present principles; and

FIG. 5 is a state diagram showing states and transitions of a reactor in accordance with the present principles;

FIG. 6 is a block/flow diagram showing operations performed by a reactor in accordance with the present principles; and

FIG. 7 is a block/flow diagram for composing an order independent set of declarative rules for a reactor in accordance with one illustrative embodiment.

### DETAILED DESCRIPTION OF PREFERRED EMBODIMENTS

A kernel of a simple and uniform programming model called a reactor model is provided. The reactor model is suitable for building and evolving internet-scale programs. Such programs are characterized by collections of loosely-coupled distributed components that are assembled on the fly to produce a composite application.

A reactor includes two principal components: mutable state, in the form of a fixed collection of relations, and code, in the form of a fixed collection of rules in the style of datalog. A reactor's code is executed in response to an external stimulus, which takes the form of an attempted update to the reactor's state.

As in classical process calculi, the reactor model accommodates collections of distributed, concurrently executing processes. However, unlike classical process calculi, observable behaviors are sequences of states. Similarly, the interface to a reactor is simply its state, rather than a collection of message channels, ports, or methods. Also, both synchronous and asynchronous component composition are permitted. In one embodiment, datalog-style rules allow aspect-like composition of separately-specified functional concerns in a natural way, and thus simplify composition, evolution, and maintenance of distributed applications.

Embodiments of the present invention can take the form of an entirely hardware embodiment, an entirely software embodiment or an embodiment including both hardware and software elements. In a preferred embodiment, the present invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Introduction to the Reactor Model: The reactor model is a synthesis and extension of key ideas from three linguistic foundations: synchronous languages, (See, e.g., N. Halbwachs, “Synchronous programming of reactive systems, a tutorial and commented bibliography” in Tenth International Conference on Computer-Aided Verification, CAV'98 (Vancouver (B.C.), June 1998), LNCS 1427, Spring Verlag), Datalog (See, e.g., J. D. Ullman, “Database and Knowledge-Base Systems”, vol. 1, Computer Science Press, 1988, ch. 3, incorporated herein by reference.), and the actor model (See, e.g., G. Agha et al., “A Foundation for Actor Computation”, Journal of Functional Programming 7, 1 (January 1997), 1-69). From Datalog, we get an expressive declarative, and readily composable language for data query. From synchronous languages, we get a well-defined notion of “event” and atomic event handling. From actors, we get a simple model for dynamic creation of processes and asynchronous process interaction.

A reactor includes two principal components: mutable state, in the form of a fixed collection of relations, and code, in the form of a fixed collection of rules in the style of Datalog. A reactor's code is executed in response to an external stimulus, which takes the form of an attempted update to the reactor's state. When a stimulus occurs, the reactor's rules are applied concurrently and atomically in a reaction to yield a response state. In addition to determining the response state, evaluation of rules in a reaction may spawn new reactors, or generate new stimuli for the current executing reactor of or other reactors. Advantageously in accordance with the present principles, newly-generated stimuli are processed asynchronously, in later reactions. A simple mechanism is provided to permit collections of reactors to react together as a unit when appropriate, thus providing a form of distributed atomic transaction.

As in classical process calculi, the reactor model in accordance with the present principles accommodates collections of distributed, concurrently executing processes. However, unlike classical process calculi, the present embodiments include observable behaviors that are sequences of states, rather than sequences of messages. Similarly, the interface to a reactor is simply its state (“REST” style), rather than a collection of message channels, ports, or methods. In accordance with a particularly useful embodiment, information hiding is accommodated by preventing certain relations in a reactor's state from being externally accessible, and by allowing the specification of database-style views, in which a publicly-accessible state is maintained as an abstraction of a more detailed private state.

One significant advantage of using data as the interface to a component, and Datalog as a basis for defining program logic, is that the combination is highly “declarative” in the sense that it permits separately-specified state updates—written as rules—to be composed with minimal concern for control and data dependence or evaluation order. This approach accommodates “aspect”-like composition of separately-specified functional concerns to be composed in a natural way.

The reactor model as provided in accordance with the present principles is unique in at least combining the following attributes harmoniously in a single language: 1) data, rather than ports or channels act as the interface to a component, 2) synchronous and asynchronous interaction are handled in the same model, with the ability to generate processes dynamically, 3) expressive data query and transformation constructs are provided, 4) the ability to specify constraints/assertions as a natural part of the core language is provided, 5) distributed atomic transactions are provided, 6) declarative, data-driven, compositional specification of functionality are enabled in an “aspect-like” manner.

In accordance with the present principles, a programming model is provided for reactive distributed applications which has a same model for presentation, business logic, data access, simplifies composition, evolution, and application maintenance. Target applications include web applications, distributed business applications, “software supply chains”, and the like.

Consider the following reactor declaration:

### EXAMPLE 1

### Order Entry, REST Style

```
def OrderEntry = {
    (* each order entry consists of an orderid (presumed
unique), an itemid, and a quantity *)
        public orders:  (int, int, int).
    (* log entries have same components as orders *)
        log:  (int, int, int).
      log (id, itemid, qty)  <- orders (id, itemid, qty).  }
```

This reactor type declaration defines a class of reactors that log orders, say, for online catalog applications. Reactor instances are created dynamically, using a mechanism described herein after. The state of a reactor is embodied in a fixed collection of relations. These are relations in the database sense-sets of fixed-arity tuples of values. The state of each OrderEntry reactor in this example includes two relations, orders and log, each of which is a collection of 3-tuples of integer values. Relation orders has the access annotation public, which means that the contents of orders may be read or updated by any client. By “update”, it is meant that tuples may be added to or deleted from orders; no other form of update is possible for this embodiment. Relation log, lacking any access annotation, is private, the default, and may thus only be read or updated by the reactor itself.

A reaction occurs when an update bundle from an external source is processed by the reactor. An update bundle may be a collection of updates, one for each public relation of a target reactor (update bundles target a reactor). Each update may be a pair of sets of tuples of values. Update bundles or update information may include scalars or other types of updates. In this example, one set is the addition set Δ⁺, a set of tuples which are to be added to the associated relation; the other set is the deletion set Δ⁻, including tuples which are to be deleted from the associated relation. In the examples that follow, only one relation will be updated at a time, usually adding or deleting just a single tuple. However, an update bundle can in general update any of the public relations of a reactor, and add and/or delete arbitrary numbers of tuples at a time. Update bundles are discussed in more detail below.

A reaction begins by applying an update bundle to the public relations of the reactor. The value of those relations prior to a reaction will be referred to as the reactor's pre-state. Applying the update bundle to the pre-state yields the reaction's stimulus state. The stimulus state of a reaction is (conceptually) a copy of each public relation of the reactor, with the corresponding updates from the update bundle applied.

So, for example, in the case of OrderEntry, if relation orders included the single tuple (0, 1234, 3) prior to a reaction, and a reaction is initiated by applying an update bundle with Δ⁺={(1, 5667, 2)} and Δ⁻=Ø, then the stimulus value of orders at the beginning of the reaction will be the relation {(0, 1234, 3), (1, 5667, 2)}. We will refer to the “value of relation r in the stimulus state” and “the stimulus value of r” interchangeably.

If a reactor includes no rules, the reaction ends by simply copying the values of the relations in the stimulus state to the reactor's corresponding public relations (we will refer to the state of the relations at the end of the reaction as its response state). Hence, in its simplest form, a reaction is simply a state update. However, most interesting reactors will have one or more rules.

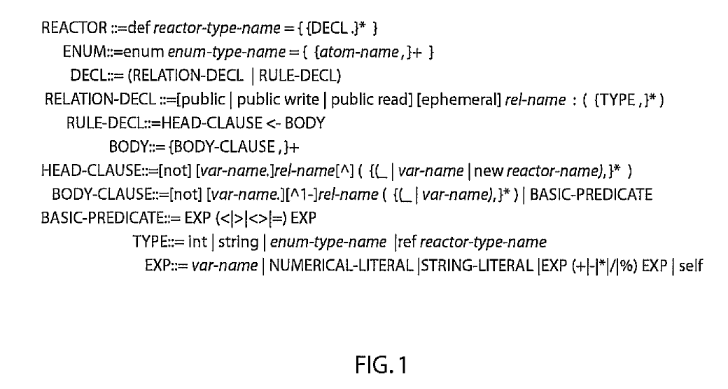

Reactor Rules: Reactor rules may be written in the style of Datalog or other relation database code; an illustrative syntax for reactors and rules is depicted in FIG. 1. The single rule of OrderEntry can be read to mean Ensure that at the end of the reaction, log contains whatever orderids are in the stimulus state of order, in addition to those orderids that were already in log prior to the reaction (i.e., in the stimulus state of log). Hence in the case where orders={(0, 1234, 3)} and log={(0, 1234, 3)} prior to the reaction and the update bundle contains the addition set {(1, 5667, 2)}, the stimulus value of orders will be equal to {(0, 1234, 3), (1, 5667, 2)}. The reaction ends when rule evaluation is complete, in this case yielding a response state such that log={(0, 1234, 3), (1, 5667, 2)} and orders={(0, 1234, 3), (1, 5667, 2)}. Note that from the point of view of an external observer, a reaction occurs atomically, that is, no intermediate states of the evaluation process are externally observable, and no additional update bundles may be applied to a reactor until the previous reaction is complete.

The right-hand side, or body of a reactor rule includes one or more body clauses. In OrderEntry, there is only one body clause, a match predicate of the form orders (id, _, _). A match predicate is essentially a pattern, which binds instances of elements of tuples in the relation named by the pattern (here, orders) to variables. Here, there is only one named variable, id. An underscore is shorthand for a unique fresh variable name. Evaluation of the rule causes the body clause to be matched to each tuple of orders, binding each orderid value for each tuple matched in turn to the variable id. Since the head clause on the left side of the rule includes the same variables as the body clause, it ensures that log will include every value bound to id that is matched on the left hand side. Each clause in a rule may be regarded as a predicate in the logical sense, hence a logical reading OrderEntry's rule would be For all orderids id, if orders contains id, then log also contains id.

Now, starting with the result of the previous OrderEntry reaction described above, consider the effect of applying another update bundle such that Δ⁺=Ø and Δ⁻={(0, 1234, 3)}. This reaction will begin by deleting orders, yielding the stimulus state orders={(1, 5667, 2)}, log={(0, 1234, 3), (1, 5667, 2)}. Evaluating the rule after the deletion has no net effect on log (since the only remaining tuple in orders is already in log. Stimuli are included in the value of log in the response. Since this is already the case, the rule has no effect on log, and we get a response state such that orders={(0, 1234, 3)} and log={(0), (1)}. The effect of this rule is to ensure that log contains every orderid ever seen in orders. If we wanted ensure that log is maintained as an exact copy of the current value of orders (which would mean that it is no longer a log at all), we would employ a negative rule: not log ( [symbol] id, itemid, qty)<-not orders (id, itemid, qty). This rule has the effect of ensuring that if an orderid is not present in orders, it will also be absent from log; i.e., it encodes tuple deletion. While negation is commonly allowed in body clauses for most Datalog dialects, negation on the head of a rule is much less common.

One notable aspect of OrderEntry is that the collection of orders is directly updated by the client, rather than being mediated by a “request method” or “request port”. The “REST” (Representational State Transfer) style of web component interaction embodied by OrderEntry makes evolution of web applications easier by exposing state directly, rather than encapsulating it through access methods or ports (as in the “service-oriented” style).

Combining references to stimulus and response states: Consider now the following alternative formulation of an order entry reactor.

### EXAMPLE 2

### Order Entry, Service Style

```
def Nonce = { }
def OrderEntry2 = {
  (* order consists of an item number and a quantity *)
    public write orderRequest: (int, int).
  (* each pending order consists of a nonce, an item
      number, and a quantity *)
    public read pendingOrders: (ref Nonce, int, int).
  (* each log entry consists of a nonce *)
      log: (ref Nonce).
    (*1*) not orderRequest (item, qty) <-
        \hat{ }orderRequest(item, qty).
    (*2*) pendingOrders (key, item, qty) <-
        \hat{ }orderRequest (item, qty, key = new Nonce.
    (*3*) log(n) <- pendingOrders (n,_,_). }
```

In reactor type OrderEntry, the set of all orders active in the system is publicly readable and writable by external clients. In the alternative OrderEntry2 formulation above, the relation order-Request is intended to include a collection of order entries which are “received” as a unit in an update bundle and processed in a single reaction as follows: each entry in newOrder is transferred to relation pendingOrders for further processing. When a pendingOrders entry is created, it is given a unique key to distinguish it from unrelated orders that happen to have the same item number and quantity. Having been duly processed, the order request is deleted prior to the end of the reaction. Finally, as was the case with OrderEntry, a long entry is created for every order. Let us now consider each rule of the OrderEntry2 declaration in turn to see how this functionality is implemented.

Rule (1) has the effect of deleting all of the incoming order entries. The ‘̂’ in the clause ̂orderRequest (item, qty) refers to the stimulus value of orderRequest, i.e., the value of orderRequest at the beginning of a reaction, after an update bundle is applied. By contrast, the head of rule (1) refers to the response state of orderRequest, i.e., the desired state of the relation at the end of a reaction. Hence the rule expresses the fact that no tuple from the stimulus value of orderRequest should exist in the response state. A rule may only refer to the stimulus value of a relation in a body clause; it may not refer to it in the head. In effect, it can “read” the stimulus value, but not “write” it.

Rule (2) transfers the contents of the orderRequest relation into the pendingOrders relation (recall that such rules perform implicit iteration over the tuples matched by the rule body). The clause key=new Nonce is an instance of a basic predicate clause defined using comparison operators. Rule (2) has two body clauses. Rule evaluation ensures that the head clause of a rule is satisfied whenever all of the body clauses are satisfied. Since key is a free variable, the clause key=new Nonce always holds, and has the effect of binding key to the value of a newly-created reactor of type Nonce. Creating a reactor generates a globally-unique reactor reference. A Nonce is a trivial reactor whose only function is to serve as a generator of globally unique values; it will be convenient to use such values as keys. In the sequel, we will assume that the Nonce reactor type is predefined. Finally, as in OrderEntry1, rule (3) logs all incoming orders.

Note that the result of rule evaluation is oblivious to the order in which rules are declared (e.g., the rules are order independent). This feature makes it much easier to update the functionality of a reactor by changing the rule set, without concern for control or data dependencies. Note, for example, that rule (3) works equally well in OrderEntry and OrderEntry1; this demonstrates that rules can be used to specify orthogonal functional “concerns” in an “aspect-like” fashion.

Note also that rule (2) could be written equivalently as not orderRequest (_, _)<-0=0. Since 0=0 is a clause that is always satisfiable, this rule has the effect of asserting that after evaluation, there should be no tuples in orderRequest, i.e., that it should simply be set to empty at the end of the reaction.

NOTATIONAL CONVENTION 1 (Unconditional rules). We will use “head clause<-.” as a shorthand for an unconditional rule of the form “head-clause<-0=0.”. In OrderEntry2, orderRequest functions as a request “channel” or “port”: Incoming requests are processed and cleared (deleted) immediately thereafter. Since orderRequest is declared “public write”, it is not externally readable. Instead, the visible state of an OrderEntry2 reactor is the current value of pendingOrders, which is not publicly writable. By contrast, OrderEntry operates by allowing clients to directly manipulate its externally-visible state. The “representational state transfer” (“REST”) style of component interaction embodied by OrderEntry makes evolution of web applications easier by exposing state directly, rather than encapsulating it through access channels/ports/methods in a “service-oriented” style. A notable feature of the reactor model is that both styles are easily accommodated.

Initialization, constants, pre-state references, and reaction failure: The following reactor defines a class of “cells”: reactors that are intended to hold exactly one value.

### EXAMPLE 3

### Cell

```
def Cell = {
  public val: (int).
  live: ( ).
  (* initializations *)
    (*1*) live ( ) <-.
    (*2*) val (0) <- not −live( ).
  (* singleton constraint; if the body is satisfiable,
      the reaction fails and the reactor rolls back *)
  (*3*) not live( ) <- val(x), val(y), x <> y. }
```

Instances of “cell” include two relations: a public unary relation val with the publicly-accessible value of the cell, and a private nullary (i.e., boolean) relation, live. When a reactor is created, all of its relations are initially empty (null). Rules (1) and (2) together define an idiom which together will allow us to initialize relations to non-null values. First, consider rule (1). This rule defines live to be a constant, since its response value evaluates to non-empty (i.e., “true”) at the end of every reaction. Now, consider rule (2). In this rule, ‘−’ in the reference to relation live in the rule refers to the pre-state of the relation, that is, the value of the relation prior to the beginning of the reaction, but before an update bundle has been applied. The pre-state value of a relation is also the response value of the relation at the end of the immediately preceding reaction. As with references to the stimulus state of a relation, references to the pre-state of a relation may only appear in the body of a rule, not its head. In both cases, this amounts to forbidding “updates to the past”.

In the first reaction that occurs after reactor initialization, the pre-state value of live will be empty (i.e., “false”), hence rule (2) will cause val to be initialized to include the single value 0. However, since the pre-state value of “live” is true at the beginning of every transaction other than the first reaction following its, rule (2) will have no effect on reactions subsequent to the first, since its body will be unsatisfiable (i.e., −live( ) will be true, and hence not −live( ) will be false). This means that the cell can be freely updated following initialization; the formulation of rule (2) ensures that it is not inadvertently “reinitialized” to 0.

NOTATIONAL CONVENTION 2 (Initialization and failure). We will assume that every reactor includes the following definitions:

live: ( )

live( )<—not live( )

We will also use FAIL as shorthand for a rule head of the form not live( ). Given these conventions, an “initialization declarations” of the form: r: (int, int) init[(1, 2); (3, 4)]. will represent the following sequence declarations:

r: (int, int).

r(1, 2)<-not −live( )

r(3, 4,)<-not −live( ).

Consider rule (3) of cell. The three clauses in its body collectively check to see whether “val” includes more than one value, i.e., whether it is a singleton. If not, the rule requires that its goal clause (left-hand side) be satisfied, i.e., that “live” be set to empty (false). However, any such attempt is inconsistent with the assertion in rule (1) that live is not-empty (true). When, as in the case of non-singleton values for val there is no consistent way to satisfy all the rules of a reactor, the reaction fails. In such cases, the response state reverts to the value of the pre-state; this behavior thus amounts to rollback in transaction systems. One notable property of the reactor model is that “assertions” and “integrity constraints” in the style of databases can be expressed in precisely the same form as rules that express state updates. Note that reactions can fail for reasons other than unsatisfiability of “constraint checking” rules such as rule (3) above. It also should be noted that the if a rollback occurs all reactors involved in the reaction are rolled back. This is a form of a distributed reaction and may occur over a distributed system.

Consider, e.g., the following unconditional rules:

val (17)<-.

not val (17)<-.

These rules are inconsistent, because they attempt to simultaneously ensure that val does and does not contain 17, hence any reaction containing them would fail. While such a scenario may seem unlikely, it is possible to construct more realistic rules which can be unsatisfiable given certain initial conditions, due, e.g., to the failure of the programmer to recognize certain edge cases. An interesting challenge is to use program analysis to statically detect when run-time inconsistencies are possible. Note, however, that the possibility of runtime reaction failure is a “feature”, not a limitation, of the reactor model, since it provides a general mechanism for detecting and managing inconsistencies that are inherent in the programmer's specification.

Clients of instances of reactor type “cell” need to ensure that they maintain its singleton constraint, e.g., by deleting the current value of the cell before adding a different value. However, if desired, the declaration of “cell” could be augmented to make it easier for clients that wish to update its value to avoid having to delete the previous value by adding the following rule:

not val(x)<-−val(x), ̂val(x′), x< >x′.

This rule is interesting because it refers to all three reactor states discussed thus far: the pre-state, stimulus state, and response state. The body of the rule checks to see whether the stimulus value of val contains an item different from the pre-state. If so, the offending pre-state item is deleted from the response value of val. Note, however, that it is still possible for the singleton constraint to fail if a client attempts to insert more than one distinct in a single update bundle. This example illustrates how the declarative nature of reactor rules makes it straightforward to “progressively refine” existing functionality by adding new features in a non-intrusive way.

Asynchrony: Until this point, only how reactors react when an update bundle is applied has been explained. We now describe how updates (e.g., update bundles) are generated, and explain how this process is intimately connected to asynchronous interaction. Consider the following example, which computes successive values of a Fibonacci series:

### EXAMPLE 4

### Self-Reacting Fibonacci

```
def Fibonacci = {
    (* complete series thus far; first element
        is index, second element is value *)
  public read series: (int, int) init [ (1, 0); (2, 1) ].
    (* must be true for computation to take place *)
      public write run: ( ) init [ ( )].
    (* temporary relation holding all indices in
        the sequence less than the maximum *)
      ephemeral notLargest: (int).
    (* compute indices in “series” less than max *)
    (*1*) notLargest (n) <-
          series (n, _), series (n′, _), n′ > n.
    (* next “series” value computed from current values *)
    (*2*) series \hat{ }(n, x1+x2) <- not notLargest (n),
          series (n−1, x1), series (n, x2).
    (* halts computation if “run” set to false *)
    (*3*) FAIL <- not −run ( ), not \hat{ }run( ). }
```

The relation series includes pairs whose first element is the ordinal position of the sequence value, and whose second element is the corresponding value of the sequence. To compute the next element of the series, we need to first identify the last two elements of the series computed thus far. Universal quantification is needed to determine the maximum element of a series; however, the body of a Datalog rule can essentially encode only existential properties. To compute universal properties, we typically need auxiliary relations. Here, we use an ephemeral or “temporary” relation notLargest, which is intended to include all the indices of elements of series which are less than the maximum index. An ephemeral relation does not persist between reactions; i.e., its value at the end of a reaction is not “written back” to participate in further reactions. It may, however, be public in general, allowing it to be initialized by an update bundle (its initial value is empty otherwise). Rule (1) defines the contents of notLargest, using the following shorthand for expressions embedded in match clauses.

NOTATIONAL CONVENTION 3. A rule of the form:

r1(exp₀)<- . . . ri(expᵢ) . . . where the expᵢ are instances of nonterminal EXP in FIG. 1 and is shorthand for

r1(x0)<- . . . ri(xi) . . . , x0=exp₀ . . . , xi=expᵢ. where the xi are all fresh variables.

Rule (2) computes the next value of the Fibonacci sequence in terms of the previously-computed values in the obvious way. Note, however, that the relation in the head of the rule has the form serieŝ. A relation name of this form refers to the future state of the relation. The future state defines the contents of an update bundle which is processed after the current reaction ends, in a subsequent reaction. One can thus think of the future value of a relation as defining an asynchronous update or dispatching a “message”. As a result of the reference to the future value of series, successive values of the series are separately visible to external observers as they are added to the list. The symmetrical notation used for references to a relation's stimulus value (e.g., ̂r(x)) and a relation's future value (e.g., r̂(s) is intended to emphasize their complementary roles: a future value reference generates an update bundle, a stimulus value reference yields the value of a relation after an update bundle has been applied.

Rule (3) of Fibonacci adds a final feature: the ability to stop the computation of the series. The rule results in failure if both the pre-state and the stimulus values of run are false, thus preventing further updates to the series from being generated. Note that this rule does not prevent the state of run itself from being changed by a client.

Instances of Fibonacci can react to two distinct classes of update bundles: “internally” generated update bundles having new values of the series, and client-generated update bundles which affect the value of run. A client cannot update “series” since “series” is not public. The Fibonacci reactor does not produce update bundles affecting the value of “run”, since it has no rules referring to the future value of “run”. Therefore, update bundles will either contain updates to “series” or “run”, but not both.

In general, distinct reactors operate concurrently and independently (although multiple reactors can react as a unit in certain situations). Given this fact, it is possible for multiple “source” reactors to generate update bundles defining update bundles for a same “target” reactor. In the case of a Fibonacci reactor instance, it is possible for an update bundle to be generated by a client attempting to update the value of “run” while a previous reaction by the instance is in progress. Since reactions take place atomically, pending client updates are enqueued until the previous reaction is complete. To this end, every reactor has an associated inbox queue including a multiset of pending update bundles (or other update information). When a reaction is complete, the reactor checks for the existence of a new update bundle. If one is present in the queue, it is dequeued and used to initiate a reaction. If none is present, the reactor is quiescent until a new update arrives. The order in which inbox items (update bundles) are processed should be performed fairly.

Depending on the order in which update bundles destined for a Fibonacci instance are reacted to, it is possible for the same element of the series to be generated more than once. This poses no problems, since adding the same series element more than once to the same relations has no net effect. Nonetheless, it is possible to rewrite Fibonacci in such a way to ensure that every element of the series is generated exactly once.

While Fibonacci is designed such that update bundles can only update one relation at a time, update bundles can in general include updates to more than one relation. Consider, e.g., a client that wishes to update ordered trees (e.g., XML trees) maintained on a server. Ordered trees can be maintained using two relations on nodes: a parent-child relation, and a next sibling relation. In this case, it is natural for an update to affect both relations.

Reactor references and asynchronous interaction: Until now, our examples have only considered a single reactor type (excepting the trivial case of Nonce). Consider now the example below.

### EXAMPLE 5

### Asynchronous Query/Response

```
def Sample = {
  (* reactor reference to sensor; assumed to be
      initialized by client *)
    public rSensor: (ref Sensor).
  (* samples collect thus far; uses nonce to distinguish
      multiple measurements of the same sample *)
      public log: (ref Nonce, int)
  (* “ports” for interaction *)
      public write ephemeral pulse: ( ).
      public write ephemeral response: (int).
  (* dispatch request for “value” when “pulse” set *)
      (*1*) s.request\hat{ }(self) <- \hat{ }pulse ( ), rSensor(s).
      (* process response by adding sample to log *)
      (*2*) log(new Nonce, r) <- \hat{ }response (r). }
def Sensor = {
  public write ephemeral request: (ref Sample).
  public val: (int).
  (* dispatch response when client sets “request” *)
      r.response \hat{ }(v) <- value (v), \hat{ }request (r).
    (* singleton constraint *)
    FAIL <- val(x) <val(y), x <> y. }
```

Reactor types “Sample” and “Sensor” encode a “classical” asynchronous request/response interaction. To enable two reactor instances to communicate, we use reactor references such as those stored in relation rSensor. Rule (1) of “Sample” has the effect of dispatching an asynchronous request for the current value maintained by a “Sensor” when the client of “Sample” updates pulse. The expression s.request̂(self) in Rule (1) includes an indirect reference to relation rSensor: First, the reactor reference stored in relation rSensor is bound to variable s, then we refer to relation “request” of the sensor instance indirectly using the expression s.request since we refer to the future value of s.request, an asynchronous update bundle is dispatched to the sensor instance containing a self-reference to the requester instance, which is generated by the self construct.

A Sensor instance responds to a request by dispatching the current value of the sensor by setting the response relations indirectly via a reactor reference set by the requester. The response is asynchronous, since r.responsê refers to a future value. The requester processes the response from the Sensor instance similarly by updating the log with the value of the response.

Note that Rule (2) of “Sample” has multiple heads; this is simply shorthand for separate rules, each with one head, sharing the same body.

To instantiate and connect Sample and Sensor instances together another reactor includes a rule of the following form:

s.rSensor(d)<-s=new Sample, d=new Sensor.

This rule creates instances of both Sample and Sensor, and updates the rSensor relation of the generated Sample instance to point to the Sensor instance. A request-response cycle between Sample and Sensor instances needs three distinct reactions: the reaction in which a Sample client sets pulse (which dispatches the request to the sensor), the reaction in which the sensor responds to the request, and the reaction in which the requester updates the value of log.

Composite synchronous reactions: In example 5, two reactor instances interacted asynchronously. Consider now example 6.

### EXAMPLE 6

### Classic Transaction

```
def Acct = {
    public balance: (int).
    (* singleton constraint on balance *)
  FAIL <- balance (x), balance (y), x <> y.
    (* negative balances not allowed *)
  FAIL <- balance (x), x < 0. }
def Minibank = {
    (* request consists of transfer amt,
        to account, from account *)
      public write ephemeral transferReq:
        (int, ref Acct, ref Acct).
    to.balance (x+amt), not to.balance (x) <-
      \hat{ }transferReq (amt, to, _), to.balance (x).
    from.balance (y−amt), not from.balance (y) <-
      \hat{ }transferReq (amt, _, from), not from.balance (y). }
```

in example 6, an instance of MiniBank receives asynchronous requests to transfer money between accounts. As with Example 5, we use references to “plumb” the reactors together. However, note that the references to the balance relations of the two accounts refer to their response value, not their future value; e.g., we use to. [symbol] balance (x+amt) rather than to balancê (x+amt). This means that if a reaction is initiated by an update bundle with a new request tuple at an instance of MiniBank, the scope of the reactor will extrude to include both of the account reactors (referred to by variables to and from, respectively). This will result in a composite, synchronous, atomic reaction involving three reactor instances. Scope extrusion is an inherently dynamic process, similar to a distributed transaction: the scope of a reaction extrudes to include affected reactors whenever an indirect relation reference is written to. Details of the scope extrusion process will be described hereinafter.

Note that the rules Acct encode constraints on the allowable values of balance. In a composite reaction, all of the rules of all of the involved reactors must be satisfiable in order for the reaction to succeed. If any of the rules fail, the composite reaction fails, and all of the reactors revert to their pre-reaction states. A composite reaction is always initiated at a single initiation site, the reactor instance at which some asynchronously-generated update bundle is processed. In the case of Example 6, a composite reaction is always initiated at a MiniBank instance.

Reactors involved in a composite reaction may separately define future values for relations of the same reactor instance. In such cases, a single update bundle, combining the composite future value updates for all of the involved reactors, is dispatched at the end of the composite reaction to each target reactor. In this sense, from the point of view of an external observer, a composite reaction has the same atomicity properties as a reaction involving a single reactor.

Composite reactions and user interface components: A somewhat more complete example is shown in Example 7, the following shows how multiple user interface components can be instantiated dynamically based on the current contents of an associated database. This mimics the process of building dynamic, data-driven user interface components.

### EXAMPLE 7

### Data-Driven UI

```
def ButtonWidget = {
  public label: (string).
  public write ephemeral pressed: ( ).
  FAIL <- label (x), label (y), x <> y, }
def OutputWidget = {
  public label: (string).
  public val: (string).
  FAIL <- label (x), label (y), x <> y.
  FAIL <- val (x), val (y), x <> y. }
def DataDisplay = {
  (* database: entry is (itemid, qty) pair *)
    public db: (int, int)
  (* list of button / output widget pairs,
      indexed by itemid *)
    widgets: (int, ref ButtonWidget, ref OutputWidget).
  (* labels of widgets are constants *)
      (*1*) o.label (“Inventory: ” ) <-widgets (_, _, o).
      (*2*) b.label (“Click to decrement”) <-
          widgets (_, b, _).
  (* projection of relations onto their itemids *)
      ephemeral childItemsPrev: (int).
      ephemeral dbItems: (int).
      (*3*) childItemsPrev (i) <- -widgets (i, _, _).
      (*4*) dbItems (i) <- db (i, _).
  (* add new child widget if new item added to db *)
      (*5*) children (i, new ButtonWidget,
          new OutputWidget) <-
          db (i, _), not in childItemsPrev (i).
  (* delete widgets if corresponding item removed from db *)
      (*6*) not widgets (i, _, _) <-
          -widgets (i, _, _), not dbItems (i).
  (* output value set to qty of corresponding item *)
      {*7*) o.val (toString (q)), not o.val(s) <-
          widgets (i, _, o), db (i, q), −o.val(s).
  (* button increments qty of corresponding item *)
      (*8*) db (i, q−1), not db (i, q) <-
          −db (i, q), widgets (i, b, _), b.pressed ( ). }
```

The basic idea of DataDisplay is that a button and an output field are generated for each item in a database. ButtonWidget and OutputWidget are reusable user interface components representing the button and output field generated for each item in relation db. The buttons thus generated are “active”: pushing them causes the associated data to be decremented, which in turn results in updates to the user interface (UI).

Rules (1)“(2), (3)” and (5) together create new widgets for each item in db. Rules (1) and (2) initialize the labels for the widgets. Although the rules for ButtonWidget and OutputWidget are simple constraints, we note that the rules for newly-created reactors are evaluated as part of the “parent” reactor that created them. Rule (7) sets the value of the output field to the value of the quantity currently maintained in the database. Rule (B) “wires” together corresponding button and database items such that when a button is pressed, the corresponding data item is incremented.

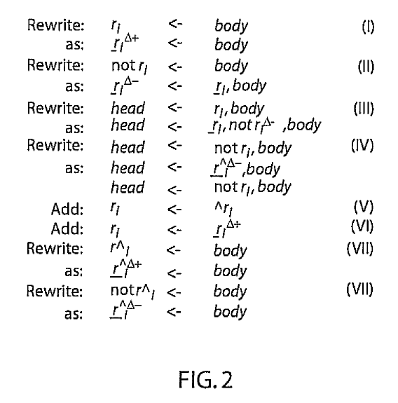

Referring to FIG. 2, program code showing core syntax for a reactor in accordance with one illustrative embodiment is shown. A reactor includes relations and rules, and can be classified as a reactive, single-threaded, stateful unit of distribution. It is sufficient to note, that the rules of a reactor can refer to relations of the reactor itself (local relations) and of other reactors (remote relations) both in the body and in the head. Conceptually, a rule reads all relations that appear in the body as well as any relations that appear in negated form in the head. Thus, a rule's need for read access can be determined statically. Though in practice, one will never read additional relations after it has become clear that the body cannot not match any tuples. Whether a rule will write the head relation when evaluated can generally only be determined at runtime, because the read has to match a non-empty set of facts that satisfy the body for a write to occur. For this reason, we will use the term read to refer to the static property, regardless of any optimization that might avoid unnecessary reads. The term write, on the other hand, will be strictly reserved for the dynamic property, i.e. a head relation is considered to be written only if the body yields at least one match when evaluated.

Relations and Enumerations: Relations are a set of (r₁, . . . , rₙ) tuples, where each rᵢ is one of the types int, string, enum-type-name, ref name. The primitive types have the usual meanings. Reactor references, ref name, are described below. Relations are empty when a reactor is instantiated. When a tuple x is present in a relation r, we say that r(x) is a fact. Enumerations introduce a new type ranging over a finite set of constants (i.e., nullary type constructors). E.g., enum season={Spring, Winter, Summer, Fall}. introduces the type season with four constants.

In addition to regular relations, which persist between reactions, a reactor can declare ephemeral relations. These relations can be written and read internally and externally exactly the same way as regular relations, but they are not persisted between reactions.

Reaction: A reaction begins when a reactor receives an update bundle. An update bundle may be a total map from the set of public relation names of the recipient to pairs of sets (Δ⁺, Δ⁻) where Δ⁺ and Δ⁻ are sets of tuples to be added and deleted, respectively, from that relation, and Δ⁺∩Δ⁻=Ø. An update bundle should include at least one non-empty set, i.e. completely empty update bundles are not well-formed.

The state of a reactor before an update bundle is received is called the pre-state. The update bundle is applied to the pre-state of a reactor to yield the stimulus state, as a result. Additionally, the reaction can generate updates for some future state, and these updates form the update bundles that initiate subsequent reactions. In response to the update bundle, the reactor evaluates all its rules and while doing so it may extrude the scope of the reaction to include other reactors. Extrusion can happen in two ways: 1. When a new reactor is instantiated it is included in the scope of the reaction that caused it to be instantiated 2. When the response state of any relations (local or remote) is written, the reactor that includes that relation and all reactors including rules reading that relation are included in the scope of the ongoing reaction. We say a relation is written whenever a rule produces a response-state update for that relation regardless if this results in a state change or not (e.g. adding an already existing tuple constitutes a write).

One exception is the passive read. A passive read is a read from the pre-state of a remote relation. It differs from other remote reads in that writes to the relation in itself will not cause the reaction to extrude to the reader. The reaction is complete when all reactors included in the reaction have reached a state that satisfies their rules, or there has been a conflict (see below) and all involved reactors revert (rollback) to their pre-state, i.e. the state they were in before the update bundle occurred or before they were included in the reaction. The transactional properties of reactions are described below.

As mentioned, a reaction may result in one or more new update bundles when it writes to the future state of any local or remote relation. A reaction may produce many update bundles, but in one embodiment may only produce one per receiver. If several different involved reactors produce update bundles for the same receiver, the updates will be grouped into one update bundle. In case the reaction rolls back, no update bundles are produced. If a reaction updates the future state of reactors C₁ . . . , Cn, it produces n different update bundles, and each Cᵢ will have a separate and independent reaction to its own update bundle. Even if the scope of Cᵢ's reaction should happen to expand to include some other Cⱼ, Cⱼ's update bundle will not be processed (or even visible) in that reaction.

The externally visible life-cycle of a reactor can be illustrated as a series of response states:

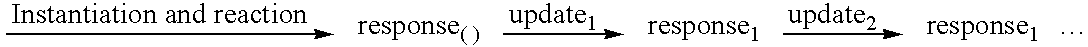

The terms pre-state, stimulus state, response state, and future state are meaningful only relative to a particular reaction because one reaction's response state is the next reaction's pre-state; and one reaction's future state splits to become the stimulus state of one or more subsequent reactions. The rules of a reactor can refer programmatically to all four states: it can read the pre-state, the stimulus state, and the response state; it can write the response state and the future state.

when a reactor begins reacting in response to an update bundle, its pre-state and stimulus state will generally be different (unless applying the update bundle yields no changes) because the contents of an update bundle is reflected in the stimulus state. Should the reaction scope extrude to (or affect) other reactors, however, their pre-state and stimulus state will be the same.

Dynamic Reactor Creation: There are several ways of introducing references to reactors. The keyword “self” when used in a rule, evaluates to a reference to the enclosing reactor. The expression new reactor-type-name instantiates a new reactor of the given type, extrudes the current reaction to include the new reactor, and evaluates to a reference in the new reactor.

Reactor references are totally ordered values that can be read, written, and compared. The total ordering is a standard Datalog requirement to allow aggregate functions (count, sum, etc.) on the domain.

Conflict and Rollback: A reaction is the evaluation of all rules of all participating reactors. As a result the rules yield additions and deletions to the response state (of involved reactors) and to the future state (of arbitrary reactors). If for any persistent or ephemeral relation the same tuple is slated both for addition and deletion, there is a conflict.

More specifically, given a reactor with persistent relations r₁, . . . , rₙ and ephemeral relations (temporaries) rₙ₊₁, . . . rₙ₊ₘ, a reaction yields for each relation a set of tuples to be added and a set of tuples to be deleted. We denote these r₁^{Δ+}, . . . , rₙ₊ₘ₁^{Δ+} and r₁^{Δ-}, . . . , rₙ₊ₘ₁^{Δ-}, respectively. Similarly, for the future state we have r̂₁^{Δ+}, . . . , r̂ₖ^{Δ+} and r̂₁^{Δ-}, . . . , r̂ₖ^{Δ-}.

if for any i, rᵢ^{Δ+}∩rᵢ^{Δ-}≠Ø or for any j, r̂ⱼ^{Δ+}∩r̂ⱼ^{Δ-}≠Ø then there has been a conflict. Note that inconsistencies between response and future states do not give rise to a conflict. Also note that ephemeral relations, even if not persisted, are still subject to consistency checks.

If there has been a conflict, all participating reactors revert to their pre-state and no update bundles are dispatched. If no conflict is detected, the additions and deletions for the response states are applied, and additions and deletions for the future states are dispatched as update bundles.

Locking and Reacting: When a reaction extends to include several reactors, the composite reaction should appear as one atomic transition in the same way a reaction with one reactor would do. The following locking conventions ensure this property.

A reactor locks when it agrees to react to an update bundle and remains locked for the duration of the reaction until either a response state is found and committed or a conflict causes the reactor to roll back to the pre-state. When a reactor is locked, it denies any interaction (including read-access, write-access, and beginning to react to other update bundles) with reactors that are not part of the same reaction.

In short, we can observe that if a reactor is locked it is either included in an ongoing reaction or at least one of its relations has been or will be read by another reactor in an ongoing reaction. The converse is not always true since an ongoing reaction may need to read the reactor, but has not obtained a lock yet. This could easily happen, e.g. if the reactor is busy serving other requests. Intuitively, reaction scope extends to include all reactors owning or (non-passively) reading relations being written, while lock dynamically extends to include all reactors owing relations being read (as well as all reactors in the reaction scope).

When a remote reactor is read, an exclusive lock on the reactor is acquired and held for the entire duration of the reaction. Should the same remote reactor need to be written later in the same reaction, this extremely defensive locking strategy guarantees that references to the remote reactor's pre-state and response state will in fact refer to two consecutive states of that reactor because it has not been free to serve any other reactions in the meantime. The problem of deadlock naturally arises in this setting and is discussed below.

Any implementation of reactors should guarantee the outlined semantics, but several optimizations are possible. First, type-based static dependency checks can determine in many cases if a read reactor is never written in the reaction. In that case the read lock can be released immediately on completion, or several readers can even be allowed concurrently if the reactor is given helper threads to serve readers. Second, an optimistic strategy can avoid maintaining read locks after the read is complete, but instead simply check that no other intervening writes have occurred, the reaction needs to write to the remote reactor.

Rules: Rule declarations can be read “for every combination of tuples that match the body, add the update requirement mandated by the head clause to the state identified by the head clause”. We found Datalog rules to be a convenient way to specify one notion of rules. Other dialects and rule sets are also contemplated. Standard Datalog programs, i.e., normal programs permit negation in the body clauses. For a general overview of standard Datalog with arithmetic see Ullman cited above. To fully support a class of target applications and the approach presented so far, the following additions are made to standard Datalog: (i) Negation in the head clauses (to express deletion); (ii) State updates (successive observable states cleanly separated from the rule evaluation); (iii) Reactor references; (iv) Unbound variables in negative head clauses.

Negation in Head Clauses: One can view deletion and additions to the response state of persistent relations rᵢ in a synchronously executing set of reactors as a two-step process: (1) as a result of applying standard Datalog techniques create a pair of relations (rᵢ^{Δ+}, rᵢ^{Δ-}) which includes the sets of tuples that will be added to and deleted from rᵢ's, then (2) outside the Datalog framework overwrite rᵢ's response states to include rᵢ^{Δ+} and exclude rᵢ^{Δ-}. The same idea applies to the response state of ephemeral relations and to the future state of both persistent and ephemeral relations. Following this intuition, if a program includes negation in any of the head clauses, the present approach transforms the negation to eliminate all such occurrences.

Stratification: It is desirable to identify a syntactic condition that would ensure that a program solution exists and it is unique for a given initial state. Stratification is such a condition. As a result of applying the present rewrite technique, we are left with a standard Datalog program. In this context, we treat each of the four states of a given relation as distinct relations. We adopt the stratified semantics for standard programs presented in the prior art. A main idea behind stratification is to partition the program along negation such that we fully compute relations before applying the negation operator. Given a Datalog program P, the dependency graph G is a directed graph [symbol] N, A [symbol] with N the set of all predicate symbols in P and aεA an edge from p to q if p and q are predicate symbols in the body and head clauses of a rule r, respectively. An arc between predicate symbols p and q is marked if the body clause that has p as a predicate symbol is negative. P is stratified if there exists no cycle in G including a marked arc. The solution for a stratified program is total and unique, and it is independent of the stratified G and the stratification that was chosen.

Safety: A desirable property of a Datalog program is that a solution depends only on the known facts and not on the universal sets of all facts. This is called domain independence. Furthermore, we would like to ensure that rule evaluation from a finite set of facts yields a finite set of results. This is called finiteness. Since both domain independence and finiteness are generally undecidable for Datalog programs with negation and arithmetic, we instead use a conservative syntactic characterization called safety. Safety guarantees domain independence and weak finiteness, meaning that a forward application of a rule from a finite set of facts yields a finite set of results, but infinite results caused by infinite recursion cannot be ruled out.

Safety is well-known in Datalog, and we will simply use the variant proposed by R. Topor, in “Safe Database Queries with Arithmetic Relations”, in Proceeding of the 14^{th} Australian Computer Science Conference (1991), incorporated herein by reference, that supports arithmetic expressions and negation. Note that this is a condition on the transformed program where the reactor-specific extensions to Datalog have been compiled away.

Briefly, a rule is safe if all its variables are limited. A variable is limited if it occurs in a non-negated clause in the body, if it occurs in a negated clause in the body and is not used elsewhere, or if it occurs in an expression where a unique value of the variable can be computed given all the limited variables of the expression. A program is safe it all its rules are safe. Consider a few examples:

(*1*) answer(x)<-mynumber(x), not zero(x)

### (*2*) P(x)<-Q(y), R(z), x+y=z

### (*3*) P(x)<-Q(y), R(z), x*y=z

Rule (1) is safe, but removing mynumber(x) renders it unsafe because x then is not limited. Rule (2) is safe because knowing y and z uniquely gives x, but rule (3) is not since if both are zero, x could be anything.

Program Transformation: To leverage the existing Datalog work while supporting our language features a program transformation technique is provided which transforms programs into standard Datalog programs. Given a reactor C with persistent relations r₁ . . . rₙ and ephemeral relations t₁ . . . tₘ, let r₁^{P}, . . . rₙ^{P} denote the contents of the relations immediately prior to a reaction; if C has just been created the relations are empty by default. Let, ̂rᵢ^{Δ+}, ̂rᵢ^{Δ-}, ̂tᵢ^{Δ+} and ̂tᵢ^{Δ-} be the addition and the deletion sets of the update bundle applied to reactor C. We can assume that ̂rᵢ^{Δ+}∩̂rᵢ^{Δ-}=Ø and ̂tᵢ^{Δ+}∩̂tᵢ^{Δ-}=Ø because this property is checked by the originating reactor before creating new update bundles. Let −r₁, . . . −rₙ denote the pre-state, ̂r₁, . . . ̂rₙ the stimulus state, r₁, . . . rₙ the response, and r̂₁, . . . r̂ₙ the future state of the reaction.

FIG. 2 shows how an illustrative rewriting technique in accordance with one embodiment transforms a program with negation in the head clauses to a program without them.

Referring again to FIG. 2, let rᵢ^{Δ+} and rᵢ^{Δ-} be the sets of tuples that need to be added to and deleted from the final solution (i.e., the response state of the persistent relations). Let tᵢ^{Δ+} and tᵢ^{Δ-} be the addition and deletion sets for the ephemeral relations. Rewrite rule (I) is straightforwardly intuitive; it computes the set of tuples to be added to rᵢ as the set of tuples that the body clauses resolve to. Rewrite rule (II) computes the deletion set very similarly; the only difference is adding a body clause which makes sure that a tuple gets deleted from a relation only if it was already there. The extra clause ensures that this rewriting rule does not introduce domain dependence. Rule (VI) adds the new addition sets to the response state as soon as they are computed; this ensures that the most current tuple additions are visible and propagating to the rest of the reactor rules. We would like to similarly account for the deletion sets but to reflect that in the response state we have to express it as negation in the rule head-exactly what the program transformation technique is trying to eliminate. Therefore the deletion sets should be accounted for and propagated via the reactor rules. Rewrite rules (III) and (IV) achieve exactly this. Rule (III) restricts the matching for the tuples in rᵢ to the ones that are not in the deletion set; conversely, rule (IV) allows matching on tuples in the deletion set. Rule (V) initializes the response state to the stimulus state. Rules (VII) and (VIII) compute the addition and deletion sets for the future state.

For ephemeral relations t₁ . . . tₘ rules (I) to (VI) apply unchanged. Rules (VII) and (VIII) do not apply for ephemerals because they do not have a future state. At the beginning of a reaction the following assignments take place: −rᵢ:=rᵢ^{P} ̂rᵢ:=̂rᵢ^{Δ+}∪−rᵢ\̂rᵢ^{Δ-} ̂tᵢ:=̂tᵢ^{Δ-}

Intuitively, the first assignment overwrites the pre-state of the current reaction's persistent relations with the contents of the relations prior to the reaction. The next assignments then apply the corresponding update bundles to the pre-state to obtain the stimulus state. Note that the deletion set of the update bundle ̂tᵢ^{Δ-} for ephemeral relations does not have any effect. These assignments are done outside Datalog. These assignments have the effect of keeping a snapshot copy of the pre-state and the stimulus state in form of IDB (intensional database relation) relations in case the rules need to read them. The copy of the pre-state is also going to be used in case of rolling back the reaction. At this point, we can apply standard Datalog techniques to evaluate the rules up to a fixpoint. If at any point during the evaluation either rᵢ^{Δ+}∩rᵢ^{Δ+}≠0, r̂ᵢ^{Δ+}∩r̂ᵢ^{Δ-}≠0, tᵢ^{Δ+}∩tᵢ^{Δ-}≠0, or t̂ᵢ^{Δ+}∩t̂ᵢ^{Δ-}≠0 the evaluation stops and the reaction rolls back. If we reached the fixpoint (without either of the checks failing) we update the response state of the current reaction, i.e., the content of the relations prior to the next reaction, to take into account the deletion sets. This assignment is done outside Datalog. rᵢ^{P}:=rᵢ\xᵢ^{Δ-}. Before quiescing, the reaction forms the update bundles (r̂ᵢ^{Δ+}, r̂ᵢ^{Δ-}) and (t̂ᵢ^{Δ+}, t̂ᵢ^{Δ-}) for other reactors and for itself, if applicable. Assuming that the transformed program is safe and stratifiable, the fixpoint solution exists, is unique and gives complete information about the reactor state.

Reactor References: In the general case, multiple reactors can be involved in a single reaction. In a naïve approach, when a set of synchronously executing reactors Cᵢ tries to extrude its scope to a new reactor Cⱼ, if Cⱼ is already involved in a reaction, Cᵢ first waits for Cⱼ to quiesce and accept Cᵢ's request for scope extrusion. Cᵢ then rolls back and both Cᵢ and Cⱼ start execution together as part of the same reaction initiated by the update bundle at reactor Cᵢ. This operation is repeated until the scope has been extended to include all reactors that need to execute synchronously.

A less naïve approach will first statically compute the transitive closure of all the synchronously executing reactors based on the type information. The goal is to coordinate the order of rule evaluation with the order of locking. The program will therefore compute the global stratification for the statically computed reactor closure; any time there is a choice of rules to evaluate next, the program will choose the one that is consistent with the global stratification. This will make sure that positive information in relations is fully computed before evaluating its negation.

The program obtained by putting together the rules of all reactors Cₖ in a reaction will include remote references to relations in Cₖ. To make all remote references local we define the following transformation. For every relation r in a reactor, the reactor defines a shadow copy r~ and an implicit rule of the following form:

r~(self, x)<-r(x)

Every remote reference c.r(x) to relation r can then be transformed into a local access to r~(c,x). At this point, the statically computed set of rules only includes local references, and statically computed set of rules is treated as one program to which we can apply the rewrite technique described above.

Implementation Issues: A reaction guarantees known ACID properties for all involved reactors vis-à-vis the environment. Specifically, (1) all involved reactors succeed or none do, (2) the response state of each involved reactor will satisfy all applicable rules upon commit, (3) reactors outside the reaction can only observe the response state and only after all involved reactors have committed, and (4) once all reactors have committed, the reaction will not be rolled back.

Given that a reaction blocks while waiting to obtain read and write access, deadlocks are possible. The optimistic locking regime mentioned herein would significantly alleviate the risk of this occurring as well as improve performance in general. The core Datalog queries are subject to aggressive optimization, and there is already a large body of research on incrementalization of Datalog queries.

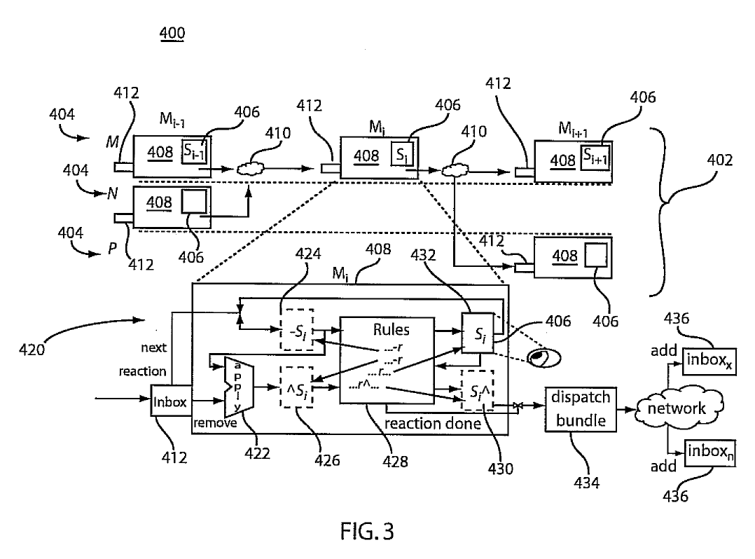

Referring now to the drawings in which like numerals represent the same or similar elements and initially to FIG. 3, a block/flow diagram illustratively shows a reaction in accordance with one system/method. A top part of the figure shows a timeline 402 for the execution of a set of reactor instances 404 labeled M, N, and P which correspond to each level on the timeline portion 402. Boxes 406 represent a visible state of each reactor 408. A network(s) or distributed system 410 show flow of reactors 408, and boxes 412 adjacent to the reactors 408 include their corresponding inboxes or inbox queue. An inbox 412 may include the multiset of pending update bundles for the associated reactor instance.

Both reactor instances M and N dispatch their update bundles at time i−1 onto the network and complete their reactions (this is an abstraction for a network, there need not be an explicit network involved). The network will insert each update bundle into the inbox 412 of its target reactor instance—in this case M. Following a fair policy, at time i reactor instance N checks for a new update bundle in its inbox, dequeues it if it exists, and uses it to initiate a new reaction. Similarly, at the end of this reaction new update bundles are dispatched for reactor instances M and P.

The internal portion of a reactor (Mᵢ) 408 is shown in portion 420 of FIG. 3. The box 406 is the same visible state as in the top part of the figure, which is referred to as the response state. An update bundle in the input box 412 is a total map from a set of relations in the state of the target reactor instance to pairs of sets of tuples to be added and deleted from the target relation. When a new update bundle is dequeued from the inbox 412, its additions and deletions are applied in an apply operation 422 atomically on a pre-state 424 (−Sᵢ) to obtain the stimulus state 426 (̂Sᵢ). The pre-state 424 is a response state of the reactor instance at the end of the previous reaction. The stimulus state 426 is a candidate response state (Sᵢ) in the sense that if the reactor includes no rules, a response state 432 is identical to the stimulus state 426.

If the reactor does include rules 428, they will repeatedly execute (recursively) until no more tuples are added nor deleted from the relations and the reaction quiesces. Rules 428 can read the pre-state 424, stimulus state 426, and response state 432 and can write the response and a future state 430 (Sᵢ̂) of local or remote reactors. Accessing a remote reactor instance's response state 432 will extrude the ongoing reaction to include the remote reactor instance in the reaction.

FIG. 3 shows a reaction involving a reactor instance. Writing the future state 430 effectively defines the update bundles that will get dispatched at the end of the current reaction. If multiple reactor instances are involved in the same reaction, there will be a single update bundle 434 dispatched per target reactor instance. The dispatched update bundle 434 can be provided to other inboxes 436 of other reactors over the network 410. From the point of view of an external observer, a reaction occurs atomically. A reactor's computation can generate new state updates for other reactors or the same reactor and can dynamically instantiate new reactors.

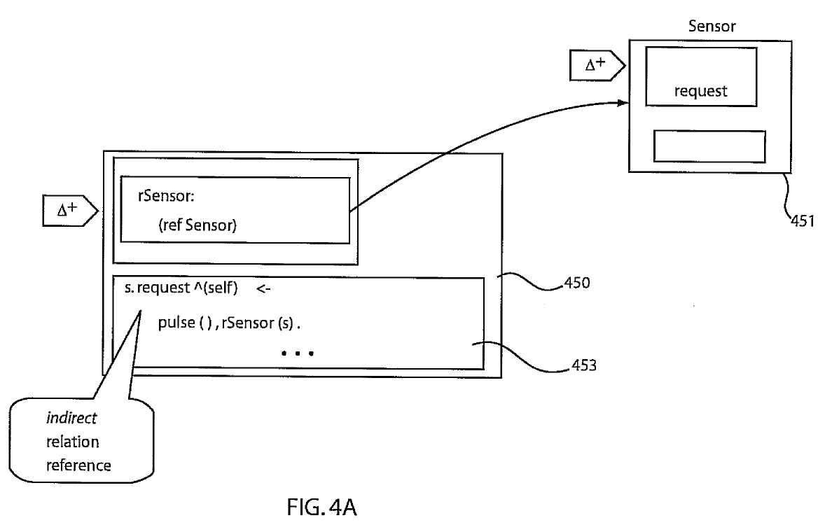

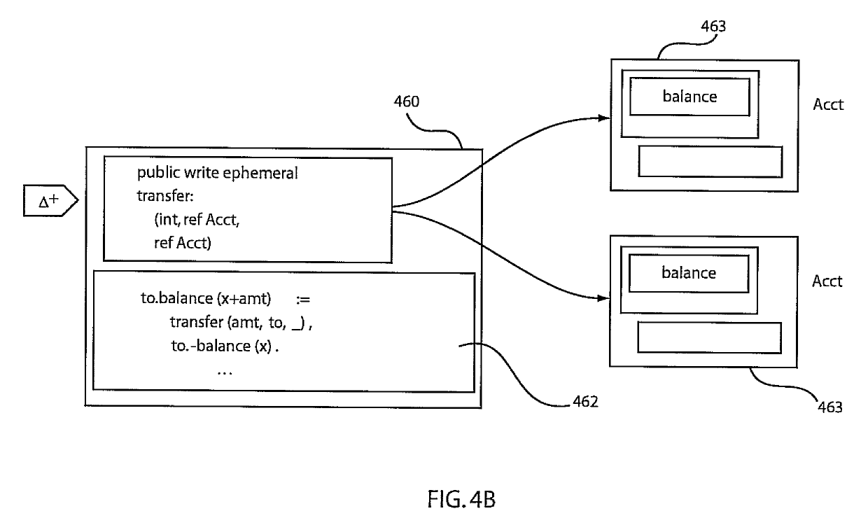

Referring to FIGS. 4A and 4B, one mechanism for reactors to interact with each other is to read and write other reactors' state via a reference to that the other reactor. This may be performed asynchronously (FIG. 4A) or synchronously (FIG. 4B).

Relations of a reactor 450 may include references to other reactors 451. References may be used as “targets” for synchronous or asynchronous updates. For example, in FIG. 4A, a rule 453 generates an asynchronous state update to a remote relation “request” in reactor 451 of type Sensor, and the reference to s may be found in the relation rSensor 453 of the enclosing reactor 450. References may be used as “targets” for asynchronous updates or in composite reactions: synchronous atomic reactions involving more than one reactor (FIG. 4B).

FIG. 4B shows a reactor 460 to transfer an amount between two accounts (463 and 464). A rule 462 references both account reactors 463 and 464 to synchronously transfer a balance between the accounts. := is shorthand for adding the new, and deleting the old value.

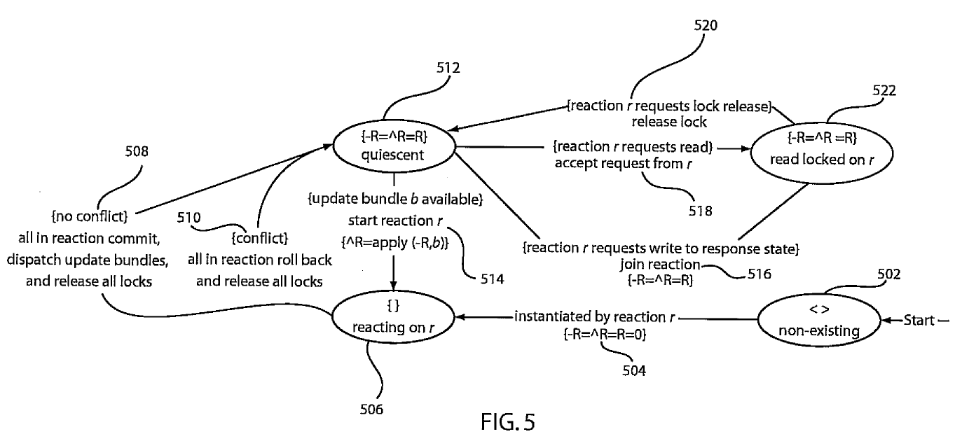

Referring to FIG. 5, an overview of a reactor state machine is illustrative shown. Transitions (edges connecting states) are written as: {precondition} activity {post condition}. States are written: {invariant} state. At the start of the process, a reactor is in a non-existing state 502. At transition 504, the pre-state −R, stimulus state ̂R, and response state R of a reactor instance are identical (the invariant). In state 506, the reactor reacts on the reaction r. Encountered conflicts in transition 510 cause the reactor state to be rolled back to a previous state and all locks are released. If no conflicts are encountered as a result of applying any rules in transition 508, all reactions are committed, update bundles are dispatched and all locks are released.

In a quiescent state 512, the pre-state, stimulus state, and response state of a reactor instance are identical (the invariant). Given a reactor instance in a quiescent state 512 if its inbox is not empty ({̂R=apply (−R, b)} where b is an update bundle in transition condition 514) the reactor instance will choose an update bundle to process in state 506. Processing the update bundle initiates a new reaction which currently includes only the initiating reactor instance (the action). As a result, the stimulus state is obtained by atomically applying the update bundle to the pre-state (the postcondition).

Rules can read and write local and remote relations. If a rule included in one of the reactor instances in the scope of the current reaction writes the response state of a remote relation, the reactor instance owning that relation joins the reaction in transition 516. Transitively, all reactor instances that non-passively read (e.g., their state would be affected) this remote relation also become part of the reaction. All the reactor instances in a reaction execute atomically from the point of view of an external observer.

A reactor instance involved in a reaction is automatically locked in state 522 for the duration of the reaction until released in transition 520 if either: a quiescent response state is found and committed (transition 508), or a conflict causes the reactor to roll back to its pre-state (transition 510). Additionally, all reactor instances owning relations being read by reactors in a reaction are similarly locked in transition 518. When a reactor instance is locked, it denies any interaction: read, write, begin to react on update bundle with reactor instances that are not part of the same reaction. As a result, the stimulus state of all reactor instances involved in a reaction except for the initial reactor instance which processes the update bundle is identical to the pre-state. Locking will guarantee that if the reactor being read needs to be written later in the same reaction, references to the reactor's pre-state and response state will refer to consecutive states.

A reaction is complete when all the reactor instances involved have reached a state that satisfies all of their rules. If one or more reactor instances cannot satisfy their rules there has been a conflict, all involved reactors roll back to their pre-state, locks are released, and no update bundles are produced. Otherwise, the reaction commits, locks are released, and update bundles are dispatched. There will be one update bundle produced per target reactor by gathering all future state updates performed by all the reactor instances involved in the committing reaction.

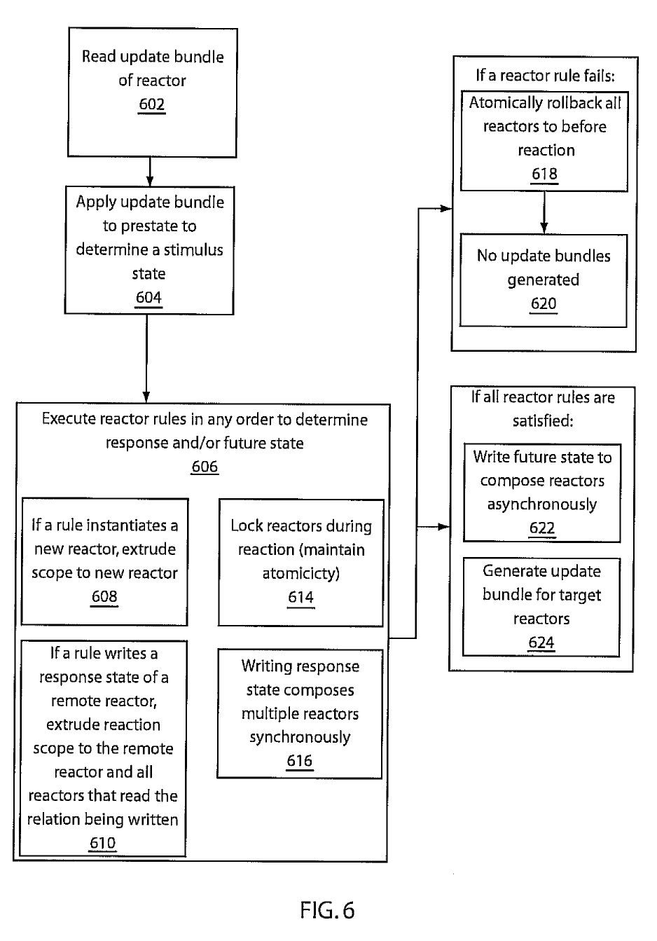

Referring to FIG. 6, a system/method for permitting interaction between applications is illustratively shown.

In block 602, ‘read’ update bundle from an inbox queue of a reactor. In block 604, apply the update bundle to a prestate to obtain a stimulus state. In block 606, execute all reactor rules atomically and in any order to determine a response state and/or a future state of the current and/or other reactors. In block 608, if a rule instantiates a new reactor, the reaction extrudes its scope to include the newly created reactor. In block 610, if a rule writes the response state of a remote reactor, the reaction extrudes its scope to include the remote reactor and all reactors including rules that read the relation being written. In block 612, the composite reaction remains atomic. In block 614, a locking convention or mechanism is employed to ensure the atomic property, a plurality of different schemes may be employed instead of or in addition to locking. In block 616, writing the response state of a remote reactor composes multiple reactors synchronously.

In block 618, if at least one rule fails to be satisfied, all involved reactors atomically roll back to their respective states before the reaction. If the reaction rolls back, no update bundles are produced in block 620. If all rules in the reaction are satisfied when their execution quiesces, in block 622, the future state of a reactor is written to compose reactors asynchronously. There will be one update bundle generated for each target reactor per reaction in block 624.

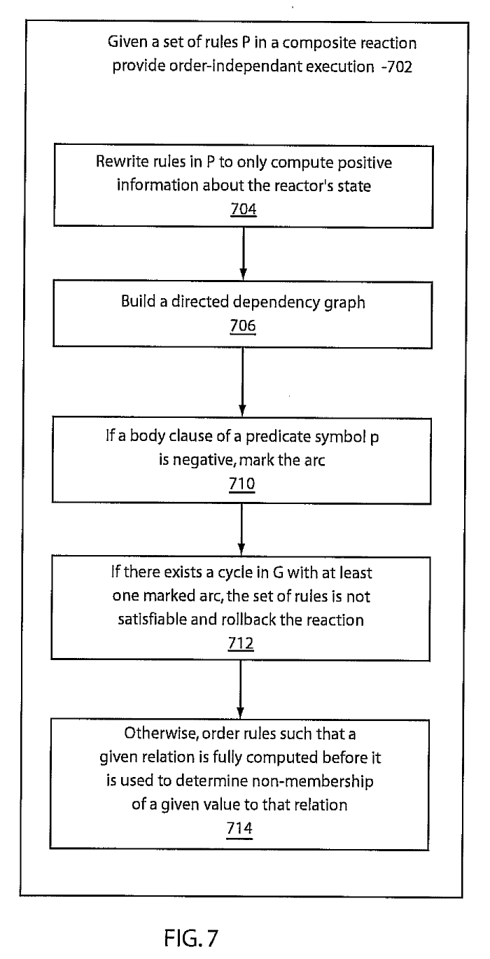

Referring to FIG. 7, an order of rule execution is irrelevant for the chosen language semantics. In other words the rules may be executed in any order, i.e., an order independent execution. One possible embodiment of the processing model for the rule execution provides the following features. In block 702, given the set of rules P of all reactors involved in a composite reaction an order independent execution is provided. This includes rewriting the rules in P to only compute positive information about the reactors state in block 704. In other words, we rewrite the rules that have negation in the rule head to get rid of the negation. This results in a new set of rules which only have negation in the rule body.

In block 706, build a directed dependency graph G: <N,A> where N is the set of all predicate symbols in P and a (in A) is an edge from p to q if p and q are predicate symbols in the body and head clauses of a rule r, respectively. If the body clause that has p as a predicate symbol is negative, mark the arc (edge) between p and q in block 710. If there exists a cycle in G that has at least one marked arc the set of rules P is not satisfiable, and the composite reaction would atomically roll back in block 712. Otherwise, in block 714, order rules such that a given relation is fully computed before it is used to determine non-membership of a given value to that relation.

Advantageously, the order-independent feature permits the application to evolve. Evolving an application by adding or removing a rule does not involve modifying the existing set of rules. The dependency graph will solely be modified by adding or removing nodes and/or edges corresponding to the rule that has been added or deleted. This property permits adding new functionality or modifying existing ones in an orthogonal, aspect-like manner.

Having described preferred embodiments of a system and method for data-oriented programming model for loosely-coupled applications (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A reactor implemented on a computer useable medium including a computer readable program, wherein the computer readable program when executed on a computer maintains data consistency in a distributed network, the reactor comprising:
an inbox configured to receive update information;
an apply operation configured to apply the update information to a prestate to determine a stimulus state based on the update information; and
a response state determined in accordance with the stimulus states the response state being an only state externally visible from the reactor by other components in a distributed network system such that the reactor reacts to the update information and initiates other reactions by its visible state in the distributed network to maintain data consistency.

2. The reactor as recited in claim 1, further comprising at least one rule which further defines at least one state of the reactor during a reaction.

3. The reactor as recited in claim 2, wherein the at least one rule includes one or more rules that are executed recursively to provide the response state.

4. The reactor as recited in claim 3, wherein the at least one rule is declarative and configured for order-independent execution.

5. The reactor as recited in claim 1, wherein the reactor remains quiescent until stimulated by an update bundle.

6. The reactor as recited in claim 1, wherein the update bundle is targeted for the reactor.

7. The reactor as recited in claim 1, further comprising a future state determined based on the prestate, the stimulus state and the response state.

8. The reactor as recited in claim 7, wherein the determination of the future state results in dispatching update bundles to other reactors including the reactor itself to asynchronously initiate subsequent reactions.

9. The reactor as recited in claim 1, wherein a reaction of the reactor occurs atomically.

10. The reactor as recited in claim 9, wherein atomicity is obtained using a locking mechanism that locks the reactor for a duration of the reaction.

11. The reactor as recited in claim 1, wherein the reactor handles both synchronous and asynchronous interactions.

12. A reactor implemented on a computer useable medium including a computer readable program, wherein the computer readable program when executed on a computer maintains data consistency in a distributed network, the reactor comprising:
a reactor state provided in accordance with at least one relation associated with the reactor, wherein the reactor state is modifiable in accordance with update information received in a distributed network system; and
at least one rule configured to maintain data consistency such that if consistency is violated a reaction fails, such that the reactor state is rolled back to a state before the reaction was initiated.

13. The reactor as recited in claim 12, wherein the at least one rule is declarative and configured for order-independent execution.

14. The reactor as recited in claim 12, wherein the reactor state is modified when the reaction succeeds and remains the same if the reaction fails.

15. The reactor as recited in claim 12, wherein the at least one relation includes a collection of relations which define the reactor state.

16. The reactor as recited in claim 12, wherein the update information includes an update bundle received by the reactor, the update bundle including information to be added and/or deleted for altering the reactor state.

17. The reactor as recited in claim 12, wherein the reactor maintains atomicity such that a response state is the only state externally visible from the reactor.

18. The reactor as recited in claim 12, wherein the reactor includes a prestate and the reactor is rolled back to the prestate if the reaction fails.

19. The reactor as recited in claim 12, wherein the reactor handles both synchronous and asynchronous interactions.

20. The reactor as recited in claim 1, wherein an interface between reactors is data, such that reactors react to data updates.

21. A method for maintaining data consistency in distributed systems, comprising:
inputting update information to a reactor;
executing all rules in all involved reactors atomically and in any order to determine at least one of a response state and a future state for the reactor and other reactors in a reaction;
if at least one rule fails to be satisfied, rolling back all involved reactors atomically to their respective states before the reaction; and
if all rules in the reaction are satisfied, generating update information for other reactors including the reactor to maintain data consistency throughout a distributed system.

22. The method as recited in claim 21, wherein generating update information for target reactors includes generating one update bundle for each target reactor per reaction when reactor execution quiesces.

23. The method as recited in claim 21, further comprising if a rule instantiates a new reactor, extruding a reaction scope to include the newly created reactor.

24. The method as recited in claim 21, further comprising if a rule writes the response state of a remote reactor, extruding the reaction scope to include the remote reactor and all reactors with rules that read a relation being written.

25. The method as recited in claim 21, wherein executing all reactor rules atomically includes providing a locking convention to ensure atomicity.

26. The method as recited in claim 21, further comprising composing multiple reactors synchronously when writing the response state of a remote reactor.

27. The method as recited in claim 21, wherein if the reaction rolls back, no update bundles are produced.

28. The method as recited in claim 21, further comprising composing reactors asynchronously when writing the future state of a reactor.

29. The method as recited in claim 21, wherein the update information includes an update bundle having tuples and further comprising applying the update information to a prestate to create a stimulus state.

30. The method as recited in claim 21, wherein the update bundle includes at least one of additions and deletions to the prestate.

31. The method as recited in claim 21, wherein the rules are recursively applied.

32. A computer program product for maintaining data consistency in distributed systems comprising a computer useable medium including a computer readable program, wherein the computer readable program when executed on a computer causes the computer to perform the steps of:
inputting update information to a reactor;
executing all rules in all involved reactors atomically and in any order to determine at least one of a response state and a future state for the reactor and other reactors in a reaction;
if at least one rule fails to be satisfied, rolling back all involved reactors atomically to their respective states before the reaction; and
if all rules in the reaction are satisfied, generating update information for other reactors including the reactor to maintain data consistency throughout a distributed system.

33. A system configured to maintain data consistency, comprising:
a plurality of reactors disposed within a distributed system, wherein each reactor includes:
an inbox configured to receive update information;
an apply operation configured to apply the update information to a prestate to determine a stimulus state based on the update information; and
a response state derived in accordance with the stimulus state, the response state being an only state externally visible from the reactor;
wherein each reactor is at least one of asynchronously responsive to update information from other reactors including the reactor itself and synchronously responsive to data being written from other reactors.

34. The system as recited in claim 33, wherein the update information includes data which includes a reference to a reactor.

35. The system as recited in claim 33, further comprising one or more rules that are executed to provide the response state, wherein the one or more rules are declarative and configured for order-independent execution.
